(19) United States
(12) Patent Application Publication
(10) Pub. No.: US 2003/0030258 A1
(43) Pub. Date: Feb. 13, 2003

(54) Arrangement of a vehicle seat in a vehicle and a method of making same

(76) Inventors: Alban Bossenmaier, Gaeufelden-Nebringen (DE); Joerg Hensel, Sindelfingen (DE); Peter Maly, Eutingen im Gaeu (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/209,196

(22) Filed: Aug. 1, 2002

(30) Foreign Application Priority Data
Aug. 2, 2001 (DE) DE 101 37.825.4

(51) Int. Cl. B60R 21/22

(52) U.S. Cl. 280/730.2

(57) ABSTRACT

An arrangement of a vehicle seat in a vehicle is proposed, an expansion area of a side airbag module being provided between the vehicle seat and an adjacent side wall of the vehicle. The vehicle seat and the adjacent side wall of the vehicle are arranged in such a manner in relation to one another that an occupant present on the vehicle seat is held, at least in his head region, at a minimum distance from an outlet opening of the side airbag module by elements of the vehicle seat and/or of the side wall.

### BACKGROUND AND SUMMARY OF THE INVENTION

This application claims the priority of German Patent Document DE 101 37 835.4, filed on Aug. 2, 2001, the disclosure of which is expressly incorporated by reference herein.

The present invention relates to an arrangement of a vehicle seat in a vehicle, an expansion area of a side airbag module being provided between the vehicle seat and an adjacent side wall of the vehicle.

Some time ago, airbags were special equipment features of motor vehicles, in particular of the superior vehicle classes. It is now more commonplace for at least one airbag, namely a front airbag in the steering wheel region and, in some instances, a passenger front airbag, to form part of the standard equipment in smaller vehicles as well.

This applies to an increasing extent for side airbags as well, the use of which likewise involves passive retention components assigned to each vehicle seat concerned. An airbag is filled abruptly with gas on a triggering signal in order to protect the person sitting on the vehicle seat concerned in the event of a collision or other accident in the vehicle.

In practice, it is common to prepare a vehicle seat in such a manner that a seat back has, at least in the forward travel direction seen towards the front, upholstery which is surrounded by a covering. In this connection, the covering runs around the seat structure arranged in the seat back and also, if appropriate, around a side airbag module arranged in the region of this seat structure. In this connection, the seat structure serves for stabilizing the seat back and usually is made of a profiled metal sheet.

The side airbag module usually comprises, as do the other airbags, a gas generator and a gas bag. If the module is triggered, the sensor-controlled gas generator produces a gas, with which the gas bag is briefly filled for roughly 30 to 50 milliseconds, so that a balloon-like protective cushion is formed for the protection of the occupant, which then relaxes so as to avoid the occupant colliding with the cushion being thrown back violently.

In German Patent Document DE 196 05 621, a vehicle seat, with a seat surface and a seat back, arranged in a vehicle in its direction of travel is described. In the region of that end side of the seat back facing outwards seen in the direction of travel, a side airbag module with a gas bag which can be inflated by means of a gas generated by a gas generator is integrated. The seat back is, at least in the region of its end face, longitudinally stabilized essentially over its entire length by means of a profiled seat structure made of rigid material. In this connection, this document proposes that at least one profiled leg of the seat structure is designed and arranged in such a manner that it completely covers the side airbag module laterally towards the outside, seen in the direction of travel, except in the region of an opening for the passage of the gas bag.

Moreover, a seat structure which has a side airbag is known from European Patent Document EP 0 788 941 and corresponding U.S. Pat. No. 6,089,594. In this connection, the seat back frame has side frames which are provided on the respective sides of the vehicle seat.

A concave portion receiving the airbag is formed on one of the side frames, which faces a vehicle door, so that the concave portion extends inward in the side frame from an end portion of the seat back frame breadthwise in the direction of the seat. The concave portion receiving the airbag receives a gas generator and a folded-together airbag. Seat upholstery is provided for covering the seat back frame, and a seat surface layer is provided for covering the seat upholstery. The seat surface layer serves for covering the seat upholstery and the concave portion receiving the airbag.

Moreover, it is also known in practice, in particular in convertibles or coupes, to provide an airbag in the region behind the interior trim in a region next to the seat, in particular on the side facing the vehicle door.

In the case of all these side airbags known from the state of the art, which are accommodated at the side in the vehicle seat or at the side of the vehicle seat, it has been found to be disadvantageous that the occupant present on the seat may be situated directly at an outlet opening of the airbag module if he is not located in a “desired position” on a seat surface of the vehicle seat.

A passenger may be in such an “out-of-position” state if, for example, he is, with his head turned backwards, reaching to the side of the seat for an article in the rear region of the vehicle seat. In such a state, the occupant may be harmed, not inconsiderably, by an airbag being inflated in the event of danger. The head of the occupant may be struck by the opening airbag, for example.

An aspect of certain preferred embodiments of the present invention is to provide an arrangement for a vehicle seat in a vehicle, with which harm to the occupant when a side airbag is inflated can also be prevented or even avoided when the occupant is in an “out-of-position” state and not in the usual “desired position”.

This aspect is achieved by way of an arrangement in that the vehicle seat and the adjacent side wall of the vehicle are arranged in such a manner in relation to one another that an occupant present on the vehicle seat is held, at least in a head region, at a minimum distance from an outlet opening of the side airbag module by elements of the vehicle seat or of the side wall.

The arrangement according to certain preferred embodiments of the invention, in which the vehicle seat and the adjacent side wall of the vehicle are arranged in such a manner in relation to one another that an occupant present on the vehicle seat is held, at least in his head region, at a minimum distance from an outlet opening of the side airbag module by elements of the vehicle seat and/or of the side wall, affords the advantage that the occupant cannot be struck directly by an airbag when it opens. Instead, the vehicle occupant is always held at a minimum distance from the outlet opening of the airbag, which is preferably selected in such a manner that, even if the airbag does make contact with the head of the passenger, the latter is hit only harmlessly by the airbag.

Such an arrangement has been found to be advantageous especially for an “out-of-position” state of the occupant concerned, as occupants present in the vehicle are not always in the “desired position”, but are frequently leaning to the side, this being so in particular as far as children are concerned.

In addition, however, it is also possible that the occupant present on the vehicle seat may enter an “out-of-position” state as a result of, for example, an extreme cornering position of the vehicle and end up in a position in which he is located precisely in or in front of the region of the side airbag. Such a situation is also common when the vehicle is already in a critical driving state before the airbag is triggered.

In this connection, the vehicle seat and the side wall of the vehicle should always extend in such a manner in relation to one another that the opening of the airbag is not hindered in order for it to be possible also to offer effective protection by the side airbag in the event of danger.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a view from above of the backseat region of a vehicle according to the state of the art,

FIG. 2 shows a view from above of a backseat region of a vehicle according to an embodiment of the present invention, and

FIG. 3 shows an embodiment with the airbag module in the vehicle seat.

### DETAILED DESCRIPTION OF THE DRAWINGS

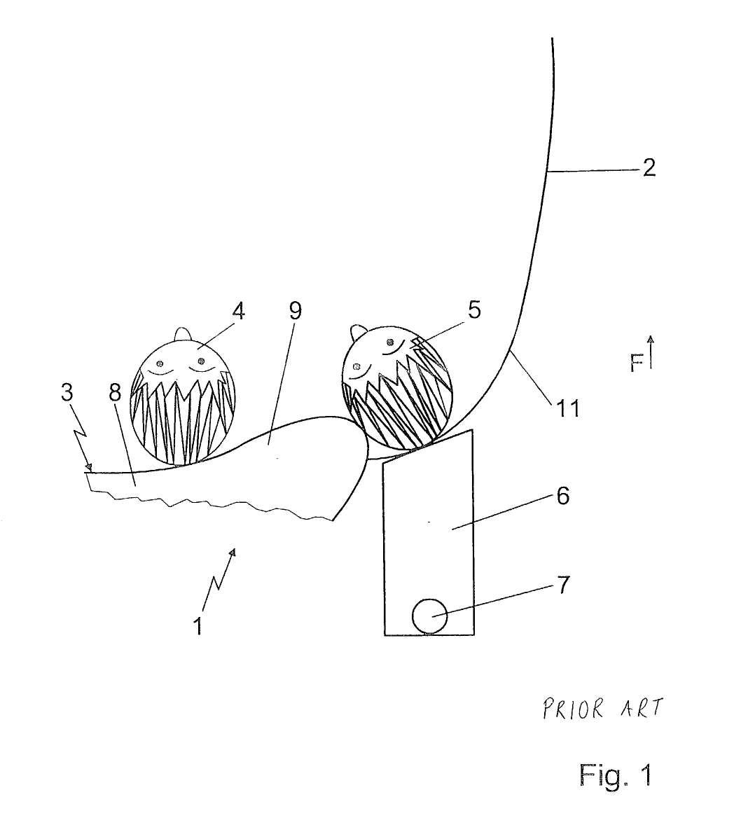

FIG. 1 illustrates the backseat region of a motor vehicle, the arrow F illustrating the forward travel direction of the vehicle, so that this is a detail from the rear right-hand part of the vehicle seen in the forward travel direction.

In this view, it can be seen that a vehicle seat 1 is arranged at a distance from a side wall 2 or lateral interior trim of the vehicle, an expansion area of a side airbag module 6 being provided between seat upholstery 3 of the vehicle seat 1 and the side wall 2, which module is, in the embodiment shown, integrated into a rear wall 11 of the interior trim of the vehicle.

The side airbag module 6 is of a construction known per se and has a gas bag which can be unfolded by a gas generator 7 in the event of a crash.

A head 4 shows an occupant on the vehicle seat 1, who is located in a desired position on a seat surface 8 of the vehicle seat 1, the vehicle occupant being stabilized in this state by lateral cheeks 9 of the vehicle seat 1, as these cheeks 9 hold the head in the region of the vehicle seat 1 during relatively strong cornering movements as well.

In addition, a further head position of the vehicle occupant is shown by reference number 5, the occupant in this case being in an “out-of-position” state, which head position occurs in back seats especially frequently where children are concerned, when they do not sit still on the vehicle seat 1.

If the airbag of the airbag module 6 is then triggered in the event of danger, the generator 7, controlled by a sensor, inflating the gas bag, the airbag emerges from the trim or the rear wall 11 in precisely the location where the head 5 of the occupant is located in an “out-of-position” state and thus catapults the head 5 of the occupant forwards.

This may lead to serious harm to the occupant, which is to be at least reduced by way of preferred embodiments of the present invention.

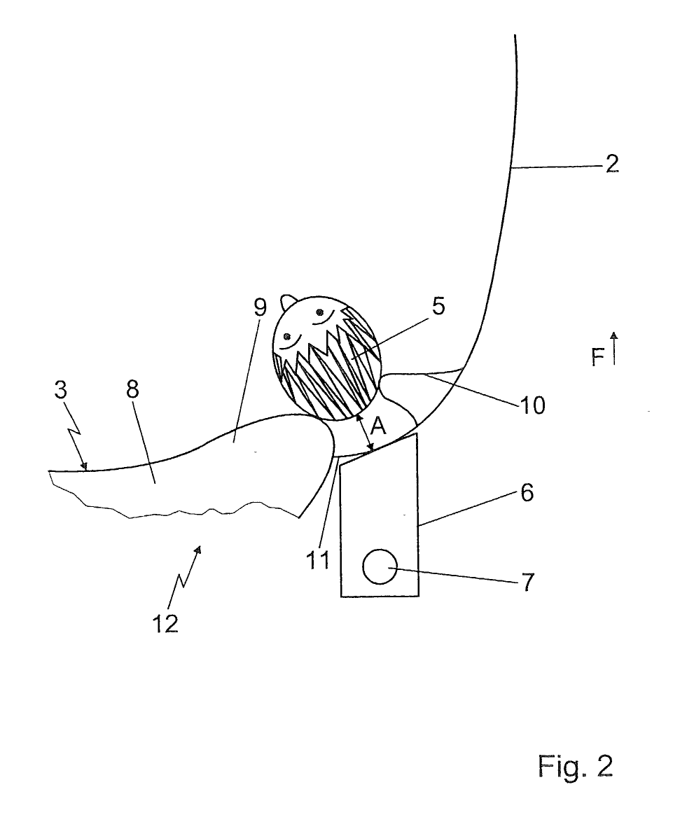

FIG. 2 shows a detail corresponding to FIG. 1 from a backseat region of a vehicle according to a preferred embodiment of the present invention. In this case, a vehicle seat 1 arranged in a vehicle, in particular in the backseat region or in a two-seat convertible or coupé, can be seen, only one seat back being illustrated in the top view. In this case too, an expansion area of a side airbag module 6 with a gas bag which can be inflated by way of a gas generator 7 is provided at the side of the vehicle seat 1, for which purpose the vehicle seat 1 is arranged at a distance from the side wall 2 of the vehicle.

In this connection, the vehicle seat 1 and the side wall 2 of the vehicle are designed in such a manner that an occupant present on the vehicle seat is always held at a minimum distance A from an outlet opening of the side airbag module 6 in an “out-of-position” state represented by the head position 5 as well. In the embodiment shown in FIG. 2, the outlet opening of the side airbag module 6 is arranged in the rear wall 11 of the vehicle interior trim, for which reason the vehicle occupant must be held at a distance from this.

In order to prevent the vehicle occupant leaning his head 5 against the outlet opening of the side airbag module 6, the back rest or the seat upholstery 3 with the lateral cheek 9 is extended outwardly in such a manner that, in interaction with a cam-like projection 10 on the side wall 2 of the vehicle, it encloses such a small interspace that this prevents the head 5 of the occupant passing through in the direction of the side airbag module 6.

The head 5 of the occupant cannot thus hit the rear wall 11 of the vehicle interior trim in the region of the airbag module in an “out-of-position” state either, as the passage remaining is too small. This small passage should be provided at least at the level of the airbag module, although there is nothing to prevent the vehicle seat 1 also being designed in such a manner that the small distance from the side wall 2 extends over the entire height of the vehicle seat 1.

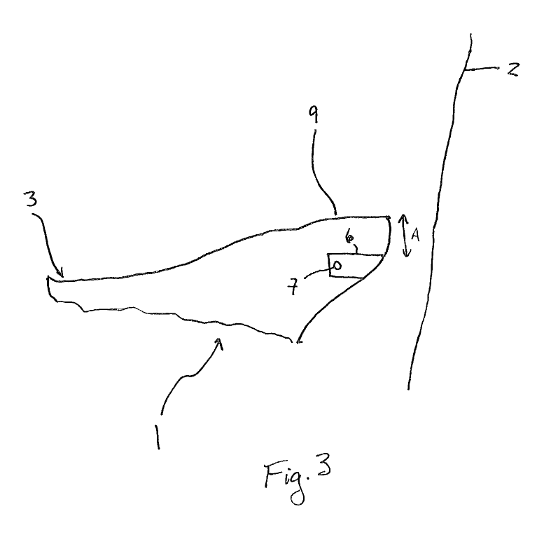

In addition, however, it would also be entirely possible for only the vehicle seat 1 to have a correspondingly large cheek 9 in order to design the distance from the side wall 2 to be so small that an occupant can no longer reach the rear wall 11 in the region of the airbag module, as shown in FIG. 3., or for the cheek 9, as is known from the state of the art, to be of conventional design and instead only the cam-like projection 10 on the lateral trim of the vehicle interior to be formed in such a manner that, again, the head 5 of the occupant cannot reach the rear wall 11.

In the event that the airbag module 6 is not arranged in the region behind the rear wall 11, but, as in the case of front seats for example, is arranged in a lateral region of the vehicle seat 1 itself, the vehicle seat 1 and the side wall 2 should be designed in such a manner that the occupant is arranged at a distance from this region.

According to an especially preferred embodiment of the present invention, the vehicle seat 1 of the vehicle is designed in such a manner that the seat upholstery 3 of the vehicle seat 1 extends in the direction of the side wall 2 in such a manner that a standard sphere with a diameter of roughly 20 cm is always arranged at a distance of at least 20 mm from the side airbag module 6. According to a further preferred embodiment of the present invention, the side wall 2 extends in the direction of the seat back 3 in such a manner that a standard sphere with a diameter of 20 cm cannot pass through the interspace. In this connection, the standard sphere corresponds to a head size, a head diameter of a small child preferably being used for dimensioning.

With the arrangement described, it is consequently also possible to prevent a small child on the vehicle seat who is in an “out-of-position” state being harmed when the side airbag opens in a dangerous situation and expands in the direction of the sensitive head.

The stated dimensions for the standard sphere and the selected minimum distance A are to be understood here as only examples. In general, however, these dimensions depend on the vehicle into which the vehicle seat 1 is being installed and also in particular on the type and the arrangement of the airbag being used.

In the embodiment according to FIG. 2 shown here, the airbag module 6 is arranged at the side of the vehicle seat 1 in the backseat region in a two-seat convertible or a coupe, where the lateral trim 2 runs directly into the rear wall 11 and to a greater or lesser extent adjoins one side of a vehicle seat 1.

Moreover, it is also possible, however, for the side airbag to be accommodated in the vehicle seat 1 itself as well. Such airbag modules 6 accommodated in the vehicle seat 1 are sufficiently familiar to the expert from the state of the art, for which reason the precise possible arrangement thereof is not to be explored further here.

The arrangement described previously in connection with the preferred embodiment shown does not necessarily have to be selected as it is; rather, it is, for example, for the vehicle seat 1 to be a seat in the front region, which is of essentially symmetrical design and in which side airbag modules 6 are accommodated in each of the two side regions of the vehicle seat 1.

In this connection, it will be clear in such an embodiment of the present invention, that not only the distance between the side wall 2 and the adjacent vehicle seat 1 is to be made smaller, but also the distance between the two seats located next to one another is to be selected to be so small that the head of an occupant is always held at a distance from the side airbag module 6 wherever it is arranged.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Arrangement of a vehicle seat in a vehicle, comprising an expansion area of a side airbag module provided between the vehicle seat and an adjacent side wall of the vehicle, wherein the vehicle seat and the adjacent side wall of the vehicle are arranged in such a manner in relation to one another that an occupant present on the vehicle seat is held, at least in a head region, at a minimum distance from an outlet opening of the side airbag module by elements of the vehicle seat or of the side wall.

2. Arrangement according to claim 1, wherein a seat back of the vehicle seat, at least in part, extends so far in a direction of a lateral trim of the side wall that the occupant present on the vehicle seat is always held at the minimum distance from the side airbag module.

3. Arrangement according to claim 1, wherein a lateral trim of the side wall, at least in part, extends so far in the direction of the seat back of the vehicle seat that the occupant present on the vehicle seat is always held at the minimum distance from the side airbag module.

4. Arrangement according to claim 1, wherein the vehicle seat and the side wall are spaced in such a manner in relation to one another that a standard sphere representing a head size is held at the minimum distance from the outlet opening of the side airbag module.

5. Arrangement according to claim 4, wherein the standard sphere has a diameter of at least 20 cm.

6. Arrangement according to claim 1, wherein the side airbag module is arranged at a side in the vehicle seat.

7. Arrangement according to claim 1, wherein the side airbag module is arranged between the vehicle seat and a lateral trim of the side wall.

8. An expansion area of a side airbag module, comprising: a volume in a vehicle bounded by a vehicle seat, a side wall of the vehicle adjacent the vehicle seat, and an outlet opening of the side airbag module,
wherein an element of the vehicle seat or sidewall ensures that an occupant present in the vehicle seat is prevented, at least in a head region, from approaching an outlet opening of the side airbag module within a distance.

9. A method of making an arrangement of a vehicle seat in a vehicle, comprising:
providing an expansion area of a side airbag module between the vehicle seat and an adjacent wall of the vehicle seat, and
arranging the vehicle seat and the adjacent side wall in relation to one another so that, in use, an occupant on the vehicle seat is held, at least in a head region, at a minimum distance from an outlet opening of the side airbag module by elements of the vehicle seat or the side wall.

10. In a vehicle having an expansion area of a side airbag module provided between a vehicle seat and an adjacent side wall of the vehicle, an element of the vehicle seat or the side wall is arranged so that the vehicle seat and the adjacent side wall are in relation to one another whereby an occupant on the vehicle seat is blocked, at least in a head region, at a distance from an outlet opening of the side airbag module.
